(19) United States
(12) Patent Application Publication
(10) Pub. No.: US 2007/0152972 A1
(43) Pub. Date: Jul. 5, 2007

(54) KVM switch system capable of invoking OSD menu by dedicated key

(75) Inventor: Wen Zhang, Shijr City (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Aten International Co., Ltd.

(21) Appl. No.: 11/325,905

(22) Filed: Jan. 5, 2006

(51) Int. Cl. G06F 3/02

(52) U.S. Cl. 345/168

(57) ABSTRACT

A keyboard-video-mouse (KVM) switch system capable of invoking an on-screen display menu or a hotkey menu with one keystroke rather than a sequence of keystrokes. The KVM switch system includes a KVM processor and at least one menu key. The menu key generates at least one trigger signal based on the keystroke and at least one command is issued to the KVM processor. The KVM processor controls an OSD module and an OSD output control circuit according to the received command to invoke the menu. The OSD module generates the video signals constituting the menu (either OSD menu or hotkey menu). The OSD output control circuit enables the video signals of the menu to be displayed on the monitor of the console.

### FIELD OF THE INVENTION

The present invention generally relates to a KVM switch system having a dedicated key for invoking an OSD menu or a hotkey menu, and more particularly, to a KVM switch system having a dedicated key for invoking an OSD and a hotkey menu to access a plurality of computers without need of a sequence of keystrokes.

### BACKGROUND OF THE INVENTION

A keyboard-video-mouse (KVM) switch connecting a console and a plurality of computers, is widely utilized to transmit KVM signals therebetween for controlling the plurality of computers from the console. An on-screen display (OSD) menu or a hotkey menu is conveniently used for operation and controlling the plurality of computers. The user can select any one of the pluralities of the computers from the OSD menu presented on a displayer coupled to the console or key-in a command in the dialog box of the hotkey menu to send the command to the computer. While the user activate the OSD menu or the hotkey menu to inspect the status of the KVM switch system or select one of the computers from a monitor of the console device, a sequence of keystrokes is necessary to invoke either the OSD menu or the hotkey menu. Moreover, at the console side, the user operates the keyboard and mouse to send the keyboard and mouse signals to the selected computer. However, the user might have to repeat the sequence of keystrokes many times in order to access to different computers. The repetition of the sequence of keystrokes might result in an inconvenient operation to be bothersome to the user. It is necessary to provide a keyboard-video-mouse switch system capable of invoking an on-screen display menu or a hotkey menu with one keystroke to avoid such bothersome operation and gives a fast, efficient, and advantage of a convenient operation for users.

### SUMMARY OF THE INVENTION

To solve the foregoing drawbacks in the prior art, it is an object of the present invention to provide a keyboard-video-mouse switch system capable of invoking an on-screen display menu or a hotkey menu with one keystroke rather than a sequence of keystrokes.

To accomplish the above objects, the present invention provides a keyboard-video-mouse (KVM) switch system capable of invoking an on-screen display menu or a hotkey menu with one keystroke operation. The KVM switch system includes a KVM processor and at least one menu key. The KVM processor routes the data between a plurality of computers and a console, and controls the KVM switch system to output a video signal from the selected computer in all or in part, and a video signal constituting the menu to the monitor. The menu key generates a trigger signal based on the keystroke to issue a command to the KVM processor to invoke the menu, wherein the menu invoked by one keystroke can be an on-screen display menu or a hotkey menu. Accordingly, there will be at least one dedicated key prepared for the on-screen display menu or the hotkey menu, or two keys for both. The system further includes a keyboard containing specific sites for the two menu keys, wherein a keyboard processor of the keyboard receives the trigger signal generated by the keystroke to the menu key, and a corresponding command will be issued to the KVM processor. Furthermore, the KVM switch system includes an on-screen display (OSD) module for generating the video signals constituting either the OSD menu or the hotkey menu and includes an OSD output control circuit enabling or disabling the video signals of the menu to be displayed on a monitor according to the command issued from the keyboard processor.

A method for enabling a keyboard-video-mouse (KVM) switch system to invoke the menus via one keystroke on a console, the method including the steps of:

generating at least one trigger signal based on the keystroke by at least one menu key;

issuing at least one command to a KVM processor of the KVM switch system according to the trigger signal generated by the menu key; and

invoking the menu to be displayed on the monitor of the console.

The keyboard processor scans the keyboard to receive the trigger signal when the trigger signal is generated by the menu key. Then, the keyboard processor issues a command to the KVM processor of the KVM switch system according to the trigger signal. The command is transmitted through either a general keyboard-mouse data channel or a command channel to the KVM processor. The KVM processor controls the on-screen display (OSD) module to generate the menu and further controls the OSD output control circuit to enable or disable the video signals of the menu. Furthermore, the KVM processor will transmit the responding signal back to the keyboard processor after receiving the command signal. However, the dedicated menu keys can be outside the keyboard. The according command to the trigger signal generated by one of the dedicated menu key is directly transmitted to the KVM processor but not from the keyboard processor.

The present invention provides dedicated menu keys for invoking the on-screen display menu or the hotkey menu with only one keystroke rather than a sequence of keystrokes. Furthermore, the present system gives a fast, efficient and advantaged operation. Moreover, the present invention specifically applies to a LCD KVM switch (or named rack-mounted KVM switch), which is integrated with a KVM switch, a customized or modified keyboard and a monitor but rather than limiting of the present invention.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 shows an embodiment of the arrangement for dedicated keys according to the present invention;

FIG. 2 illustrates a block diagram of a keyboard-video-mouse switch system, which employs a special command channel to transmit the command packet to invoke the menu according to first embodiment of the present invention;

FIG. 3 illustrates a block diagram of a keyboard-video-mouse switch system, which employs a keyboard-mouse data channel to transmit the command to invoke the menu according to second embodiment of the present invention;

FIG. 4 illustrates a block diagram of a keyboard-video-mouse switch system, which the OSD menu key and hotkey menu key are sited in the KVM switch to directly transmit the command to invoke the menu according to third embodiment of the present invention; and

FIG. 5 shows a flowchart of the method for invoking the menu via one keystroke on a console.

### DETAILED DESCRIPTION OF THE PREFERRED EMBODIMENTS

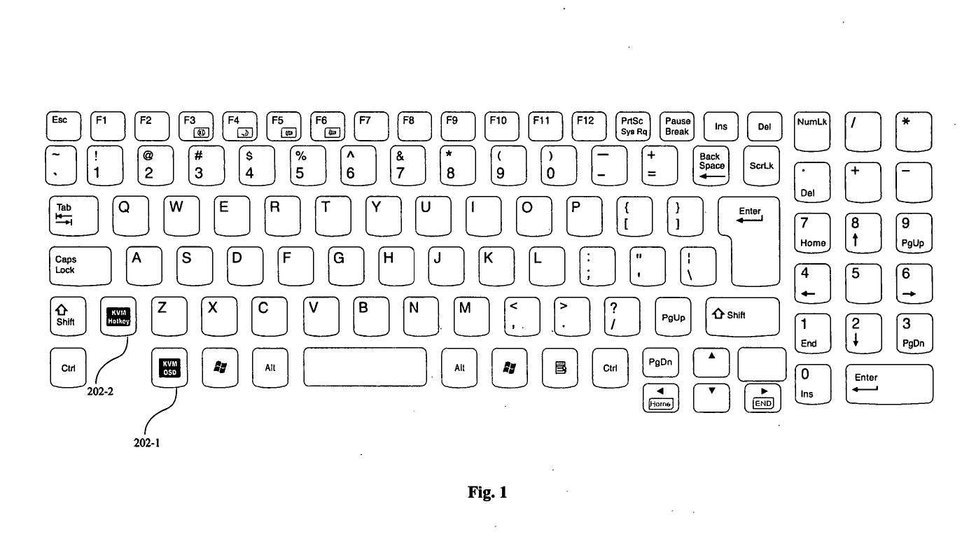

Please refer to FIG. 1. It shows an embodiment of the dedicated keys arrangement according to the present invention. A first dedicated key as an OSD menu key 202-1 and a second dedicated key as a hotkey menu key 202-2 can be sited on a customized keyboard, even embedded a lighted LED to indicate the menu operation status.

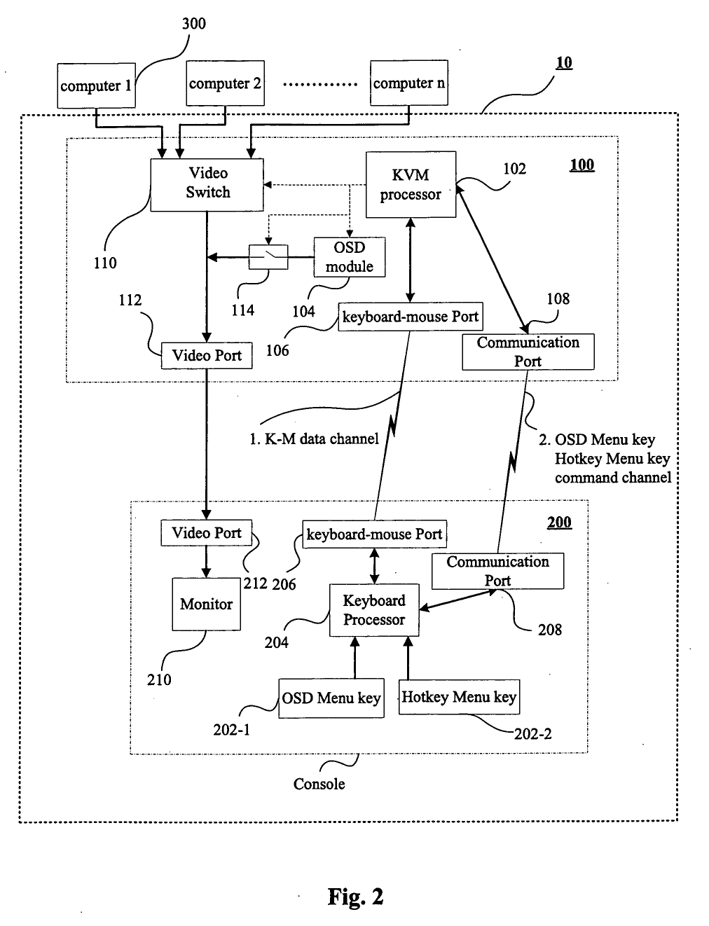

Please refer to FIG. 2 illustrating a block diagram of a keyboard-video-mouse switch system, which employs a special command channel to transmit the command to invoke the menu according to first embodiment of the present invention. The keyboard-video-mouse switch system 10 includes a KVM switch 100 and a console 200, to control a plurality of computer 1 to computer n (FIG. 2 indicates the representative computer 1 by reference 300). Although the block diagram of the keyboard-video-mouse switch system 10 shown in FIG. 2 only controls n computers, the ordinary skilled in the art can contemplate that the number of controlled computers depends on the capacity of the KVM switch. The console 200 includes the first dedicated key on the keyboard, such as an OSD menu key 202-1, the second dedicated key on the keyboard, such as a hotkey menu key 202-2, a keyboard processor 204, a keyboard-mouse port 206, a communication port 208, a monitor 210, and a video port 212. The KVM switch 100 includes a KVM processor 102, an OSD module 104, a keyboard-mouse port 106, a communication port 108, a video switch 110, a video port 112, and an OSD output control circuit 114. The KVM processor 102 mainly controls the KVM switch system to output a video signal from the selected computer or a video signal constituting the menu to the monitor. Meanwhile, the KVM processor manages all processes in the KVM switch. The video switch 110, which can be a multiplexer, is employed to switch the video source from one of the computers according to the user's selection by operating in the OSD menu.

Specifically, in the first embodiment, there are two channels for linking the console 200 and the KVM switch 100 via the keyboard-mouse port 106 and 206, the communication port 108 and 208 respectively. The general keyboard-mouse channel 1 is used for tranceiving general keyboard-mouse data, and the communication channel 2 is particularly prepared for only transmitting the command to invoke the menus and the responding signal. Then the keyboard processor 204 scans the keyboard 200 to detect whether the trigger signal is generated by the menu key (the OSD menu key 202-1 or the hotkey menu key 202-2). If the trigger signal is generated or detected by the keyboard processor 204, the keyboard processor 204 issues a command through the communication channel 2 to the KVM processor 102.

Next, the KVM processor 102 controls the OSD module 104 and the OSD output control circuit 114 according to the received command from the keyboard processor 204. The OSD module 104 then generates the video signals constituting the menu (either OSD menu or hotkey menu) in response to the command. The OSD output control circuit 114 enables the video signals constituting the menu through video port 112 and video port 212 to be displayed on the monitor 210 of the console 200. In the first embodiment, the KVM switch system 10 provides a particularly prepared communication channel 2 merely for transmitting the command to invoke the menus separately with the general keyboard-mouse data.

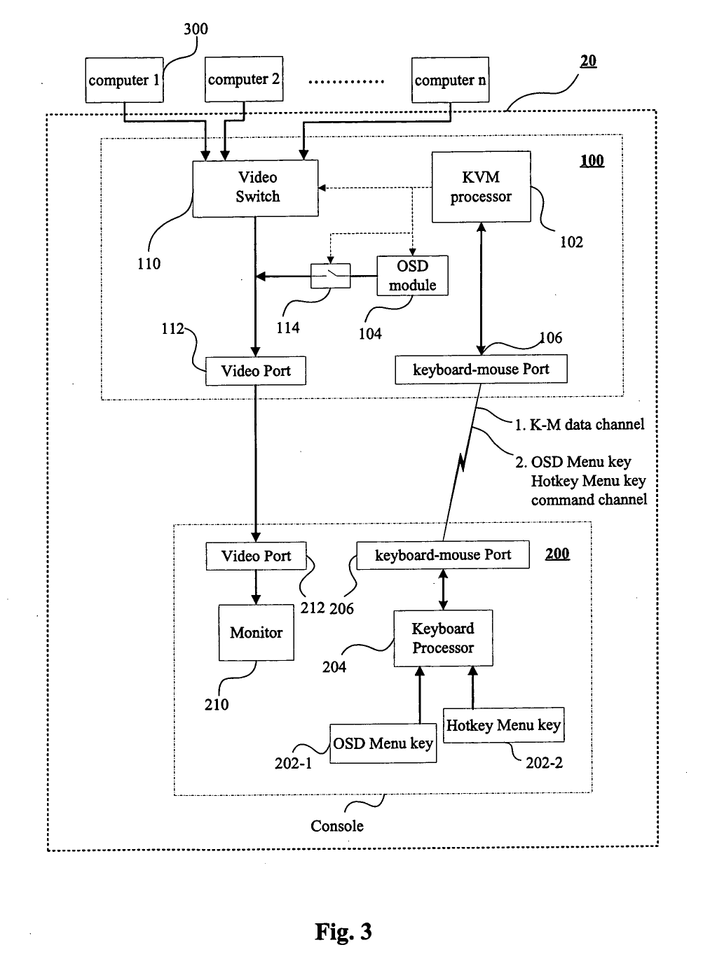

Please refer to FIG. 3 illustrating a block diagram of a keyboard-video-mouse switch system, which employs a keyboard-mouse data channel 1 to transmit the command to invoke the menu according to a second embodiment of the present invention. In the second embodiment, the command issued from the keyboard processor 204 is transmitted through a general keyboard-mouse channel 1 for omitting the particularly prepared channel (communication channel 2 in FIG. 2). Moreover, the content and format of the command transmitted through the communication channel 2 (shown in FIG. 2) will be a little different from those of the general keyboard-mouse channel 1 according to the communication standard for keyboard-mouse data. In the first embodiment, the user can define content and format of the command arbitrarily according to the channel design. Both in the first and second embodiments, the KVM processor 102 further transmits at least one responding signal back to the keyboard processor 204 after receiving the command. Otherwise, the timing for responding signal arranged after invoking the menu to indicate the operation status of the KVM switch system 10 or 20 for the operating user also will be fine. For example, to indicate the OSD menu or hotkey menu is in an “on” status, a lighted LED at the console 200 can be implemented similar to Num Lock LED or a lighted LED embedded in each of these dedicated keys.

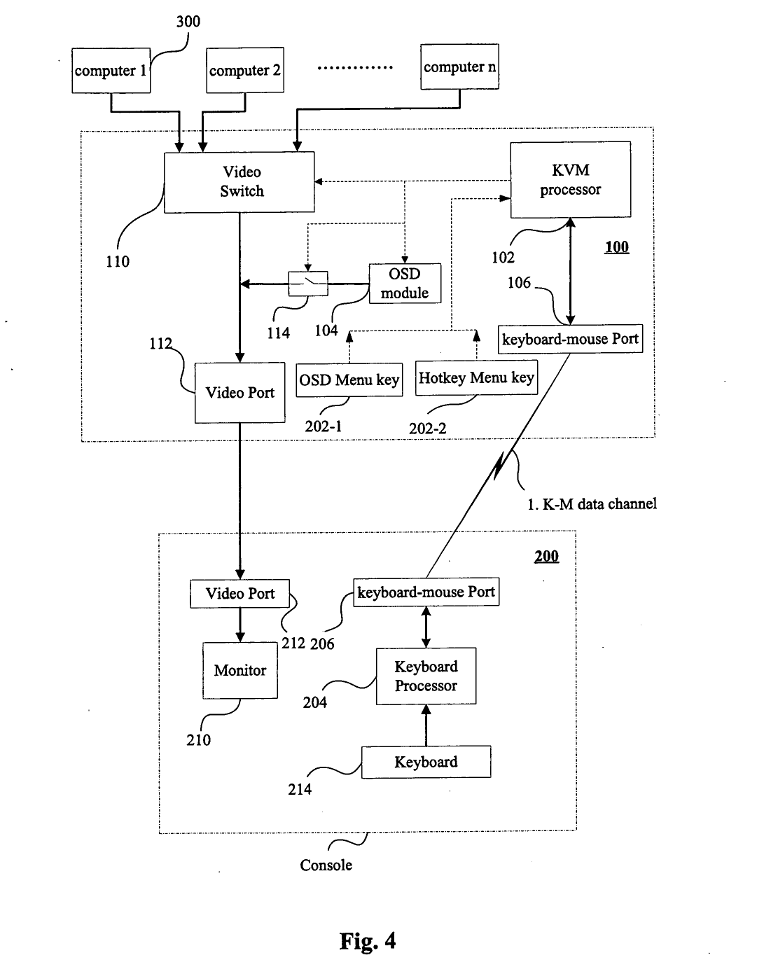

Please refer to FIG. 4 illustrating a block diagram of a keyboard-video-mouse switch system, which the OSD menu key 202-1 and hotkey menu key 202-2 are sited at the KVM switch 100 to directly transmit the command to invoke the menu according to the third embodiment of the present invention. The dedicated key for invoking the OSD menu or the hotkey menu located in the KVM switch 100 itself can be implemented in the form of a button. Once the user pushes the button, the command for invoking the menu is transmitted to the KVM processor 102. In the third embodiment, the present invention can implement the first or second embodiment together to setup the dedicated menu key in the console 200 and as a button at the KVM switch 100 at the same time. The user can invoke the OSD menu or the hotkey menu by keystroke to the dedicated key on the keyboard or pushing the button located in the KVM switch 100 at will. Accordingly, the user can invoke the menus more conveniently.

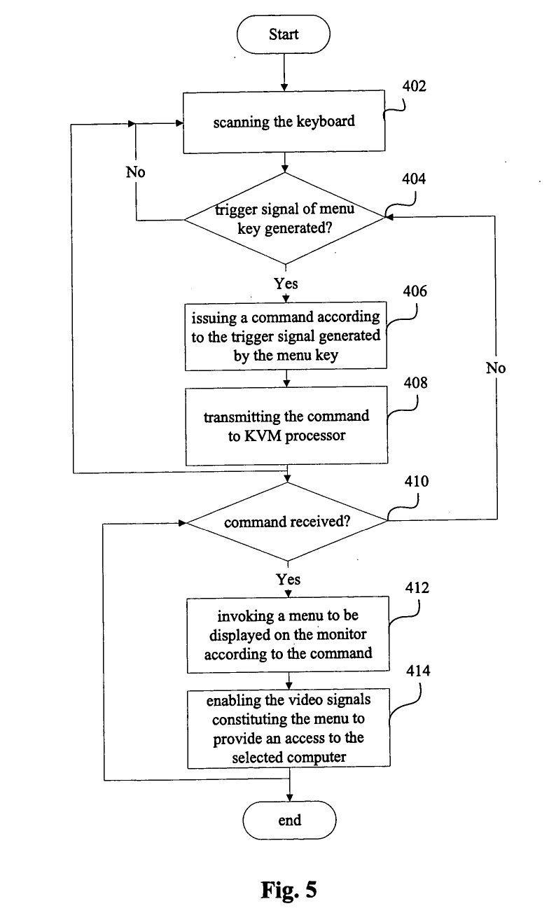

Please refer to FIG. 5, which shows a flowchart depicting the method for invoking the menu via one dedicated keystroke on a console capable of manipulating a KVM switch. Specifically, steps 402 to 408 are implemented by the keyboard processor in the console 200 shown in FIG. 2 through FIG. 3. Steps 410 to 414 are implemented by the KVM processor in the KVM switch 100 shown in FIG. 2 through FIG. 4. The method is described below:

In step 402, scanning the keyboard. The keyboard processor maintains scanning the keyboard with a predetermined interval.

In step 404, confirming whether a trigger signal of the dedicated menu key is generated or not. If “NO”, the console returns to the status of scanning the keyboard. If “YES”, it proceeds to step 406.

In step 406, issuing a command according to the trigger signal generated by the dedicated menu key.

In step 408, transmitting the command to the KVM processor of the KVM switch, then the console returns to the status of step 402.

In step 410, confirming whether the command is received or not by the KVM processor. If “NO”, the console returns to the status of step 404 to confirm again. If “YES”, it proceeds to step 412.

In step 412, invoking the menu to be displayed on the monitor of the console by the KVM processor.

In step 414, enabling the video signals constituting the menu by an OSD output control circuit according to the command.

The dedicated key for invoking a menu according to present invention can be one OSD menu key 202-1 for an OSD menu, or one hotkey menu key 202-2 for a hotkey menu. Otherwise, the present invention can employ the OSD menu key 202-1 and the hotkey menu key 202-2 in the console 200 and as buttons at the KVM switch 100 for a better consideration of the user's operation conveniently.

In conclusion, the KVM switch system according to present invention provides dedicated menu key for invoking the on-screen display menu or the hotkey menu by only one keystroke without need of a sequence of keystrokes. Furthermore, the present system gives a fast, efficient and an advantage of operation to users.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A keyboard-video-mouse (KVM) switch system, connected to a plurality of computers, capable of invoking at least one menu by one keystroke at a console, the KVM switch system comprising:
a KVM processor, controlling the KVM switch system to output a video signal from the selected computer and a video signal constituting the menu to the monitor; and
at least one menu key, generating at least one trigger signal based on the keystroke to issue at least one command to the KVM processor to invoke the menu.

2. The KVM switch system of claim 1, wherein the menu key is located in a keyboard.

3. The KVM switch system of claim 2, wherein the keyboard comprises a keyboard processor receiving the trigger signal generated by the menu key to issue the command to the KVM processor.

4. The KVM switch system of claim 3, further comprising a keyboard-mouse data channel to transmit the command issued by the keyboard processor to the KVM processor.

5. The KVM switch system of claim 3, further comprising a command channel to transmit the command to invoke the menu.

6. The KVM switch system of claim 3, wherein the KVM processor transmits at least one responding signal back to the keyboard processor after receiving the command.

7. The KVM switch system of claim 1, further comprising an on-screen display (OSD) module to generate the video signals constituting the menu.

8. The KVM switch system of claim 1, further comprising an OSD output control circuit, which either enables or disables the video signals constituting the menu to be displayed on a monitor of the console according to the command.

9. The KVM switch system of claim 1, wherein the menu key is an on-screen display menu key for invoking an on-screen display menu.

10. The KVM switch system of claim 8, wherein the on-screen display menu invoked by the command provides an access to the selected computer.

11. The KVM switch system of claim 1, wherein the menu key is a hotkey menu key for invoking a hotkey menu.

12. The KVM switch system of claim 11, wherein the hotkey menu invoked by the command provides an access to the selected computer.

13. A method for enabling a keyboard-video-mouse (KVM) switch system connected to a plurality of computers to invoke at least one menu via one keystroke on a console, the method comprising the steps of:
generating at least one trigger signal based on the keystroke by at least one menu key;
issuing at least one command to a KVM processor of the KVM switch system according to the trigger signal generated by the menu key; and
invoking the menu to be displayed on the monitor of the console.

14. The method of claim 13, further comprising a step of scanning a keyboard to receive the trigger signal generated by the menu key after the step of generating the trigger signal, wherein the menu key is located in the keyboard.

15. The method of claim 14, wherein the scanning step is used to receive the trigger signal generated by the menu key.

16. The method of claim 13, further comprising a step of transmitting the command through a general keyboard-mouse data channel during the step of issuing the command to the KVM processor.

17. The method of claim 13, further comprising a step of transmitting the command through a command channel during the step of issuing the command to the KVM processor.

18. The method of claim 13, further comprising a step of confirming whether the trigger signal of the menu key is generated or not before the step of issuing the command to the KVM processor.

19. The method of claim 13, further comprising a step of confirming whether the command is received or not by the KVM processor before the step of invoking the menu.

20. The method of claim 13, further comprising a step of enabling the video signals of the menu by an OSD output control circuit according to the command during the step of invoking the menu.

21. The method of claim 13, wherein the menu key is an on-screen display menu key.

22. The method of claim 21, wherein the menu is an on-screen display menu invoked according to the trigger signal generated by the on-screen display menu key.

23. The method of claim 13, wherein the menu key is a hotkey menu key.

24. The method of claim 23, wherein the menu is a hotkey menu invoked according to the trigger signal generated by the hotkey menu key.
